(19) United States
(12) Patent Application Publication
(10) Pub. No.: US 2025/0155666 A1
(43) Pub. Date: May 15, 2025

(54) MOBILE PHONE LENS PROTECTION COVER

(71) Applicant: Chuang LI, Guangzhou (CN)

(72) Inventor: Chuang LI, Guangzhou (CN)

(21) Appl. No.: 18/939,576

(22) Filed: Nov. 7, 2024

(30) Foreign Application Priority Data
Nov. 13, 2023 (CN) 2023230512713

(51) Int. Cl. G02B 7/02; H04M 1/02

(52) U.S. Cl. CPC G02B 7/026; H04M 1/0264

(57) ABSTRACT

A mobile phone lens protection cover includes a cover body, a light-transmitting lens and an elastic rubber ring, the cover body includes a side wall plate and a face cover defining a light-transmitting opening; the light-transmitting lens closes the light-transmitting opening and is fixedly connected with the face cover; the elastic rubber ring is arranged in the cover body; and the outer wall of the elastic rubber ring is fixedly connected with the inner side surface of the side wall plate. The cover body covers the lens, the inner diameter of the elastic rubber ring is slightly smaller than the outer diameter of the lens, the inner wall of the elastic rubber ring exerts elastic pressure on the side wall of the lens, achieving the fixation of the cover body and the lens, and the cover body is not easy to fall off.

### CROSS-REFERENCE TO RELATED APPLICATION

This application claims priority to Chinese Patent Application No. 202323051271.3, filed Nov. 13, 2023, which is herein incorporated by reference in its entirety.

### TECHNICAL FIELD

The disclosure relates to the technical field of protection covers, and more particularly to a mobile phone lens protection cover.

### BACKGROUND

With the development of technology, a lens of a camera module of a mobile phone in the related art is generally set as a convex lens protruding from a back cover of the mobile phone to obtain a larger assembly space, but the convex lens is easy to cause friction and collision with the outside, resulting in lens damage, so a lens protection cover for protecting the lens appears in the market. In the related art, the lens protection cover includes a cover body and a light-transmitting lens, the light-transmitting lens is arranged at a front end of the cover body, and an inner wall of the cover body is covered with double-sided tape. The cover body covers the lens to protect the lens and is fixed by the double-sided tape, so the cover body is not easy to fall off. In view of the above related art, the double-sided tape is in direct contact with the lens, and when the cover body is removed, the double-sided tape will adhere to the lens, polluting the lens and being difficult to clean.

### SUMMARY

In order to solve the problem that the cover body covers the lens to protect the lens and is fixed by the double-sided tape, which is in direct contact with the lens, and when the cover body is removed, the double-sided tape will adhere to the lens, polluting the lens and being difficult to clean, the disclosure provides a mobile phone lens protection cover.

A mobile phone lens protection cover includes a cover body, a light-transmitting lens and an elastic rubber ring, the cover body includes a side wall plate which is connected end to end and a face cover which closes an end of the side wall plate; the face cover defines a light-transmitting opening; the light-transmitting lens is arranged at the light-transmitting opening of the face cover to close the light-transmitting opening and is connected and fixed with the face cover; the elastic rubber ring is arranged in the cover body; and the outer wall of the elastic rubber ring is connected and fixed with the inner side surface of the side wall plate.

By adopting the above technical scheme, the cover body covers the lens, the inner diameter of the elastic rubber ring is slightly smaller than the outer diameter of the lens, and the inner side wall of the elastic rubber ring elastically squeezes the side wall of the lens, so that the cover body and the lens are fixed, and the cover body is not easy to fall off, and the cover body can be easily taken out by the elastic squeezing and fixing method, so that no residual adhesive can adhere to the lens to pollute the lens when the cover body is removed, which is more practical; and the light-transmitting lens realizes the lens to obtain light.

In an embodiment, an end of the elastic rubber ring facing away from the face cover is provided with an oblique surface, and the oblique surface forms an outward expanding flare.

By adopting the above technical scheme, the oblique surface forms the outward expanding flare, so that the entrance position of the lens is larger, and the oblique surface abuts against the lens; and by pressing the cover body hard, the cover body can be easily covered on the lens under the guidance of the oblique surface.

In an embodiment, an end of the side wall plate facing away from the face cover defines a notch.

By adopting the above technical scheme, auxiliary tools such as rigid fine needles or toothpicks are used to penetrate into the notch, so that the cover body can be conveniently picked out of the lens for separation operation, which is more practical.

In an embodiment, the face cover is convexly provided with a convex edge on the side wall of the light-transmitting opening, and the bottom surface of the light-transmitting lens is butted with the convex edge and fixed by adhesive.

By adopting the above technical scheme, the convex edge is used for supporting the light-transmitting lens, which is convenient for the installation and fixation of the light-transmitting lens.

In an embodiment, the top surface of the face cover is convexly provided with a limit ring matching the shape of the peripheral side of the light-transmitting lens, the side wall of the light-transmitting lens abuts against the inner side wall of the limit ring, and the top surface of the light-transmitting lens is flush with or lower than the top surface of the limit ring.

By adopting the above technical scheme, the limit ring to limit the movement of the light-transmitting lens makes the adhesion of the light-transmitting lens more stable, and the top surface of the light-transmitting lens is flush with or lower than the top surface of the limit ring, which is convenient for protecting the light-transmitting lens and reducing the damage caused by the collision of the light-transmitting lens.

To sum up, the disclosure includes at least one of the following beneficial technical effects.
1. The cover body covers the lens, the inner diameter of the elastic rubber ring is slightly smaller than the outer diameter of the lens, the inner side wall of the elastic rubber ring elastically squeezes the side wall of the lens, so that the cover body and the lens are fixed, and the cover body is not easy to fall off. In addition, the elastic squeezing and fixing method is convenient for taking out the cover body, and no residual adhesive adheres to the lens to pollute the lens when taking out the cover body, which is more practical.
2. The oblique surface forms the outward expanding flare, which makes it easier for the cover body to cover the lens. An end of the side wall plate facing away from the face cover defines the notch, and auxiliary tools such as a rigid fine needle or toothpick are used to penetrate into the notch, which is convenient for the cover body to be picked out of the lens for separation operation, which is more practical.
3. The top surface of the cover body is convexly provided with the limit ring matching the shape of the periphery of the light-transmitting lens, and the limit ring to limit the movement of the light-transmitting lens makes the adhesion of the light-transmitting lens more stable, and the top surface of the light-transmitting lens is flush with or lower than the top surface of the limit ring, which is convenient for protecting the light-transmitting lens and reducing the damage caused by the collision of the light-transmitting lens.

### BRIEF DESCRIPTION OF DRAWINGS

FIG. 1 illustrates a schematic structural diagram of a mobile phone lens protection cover according to an embodiment of the disclosure.

FIG. 2 illustrates a schematic structural diagram of the mobile phone lens protection cover from another angle according to an embodiment of the disclosure.

Description of reference numerals: 1. cover body; 11. side wall plate; 111. notch; 12. face cover; 121. convex edge; 122. limit ring; 123. light-transmitting opening; 2. light-transmitting lens; 3. elastic rubber ring; 31. oblique surface; 311. flare.

### DETAILED DESCRIPTION OF EMBODIMENTS

The following will provide a clear and complete description of the technical solution in the embodiments of the disclosure, combined with the accompanying drawings. Apparently, the described embodiments are only a part of the embodiments of the disclosure, not all of them. Based on the embodiments in the disclosure, all other embodiments obtained by those skilled in the art without creative labor are within the scope of protection of the disclosure.

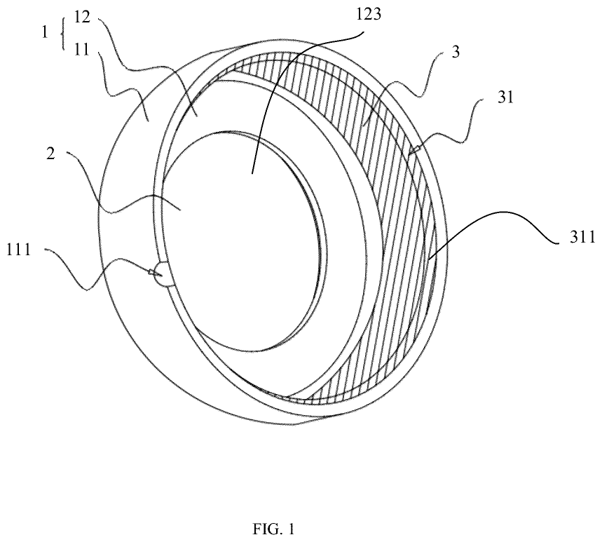

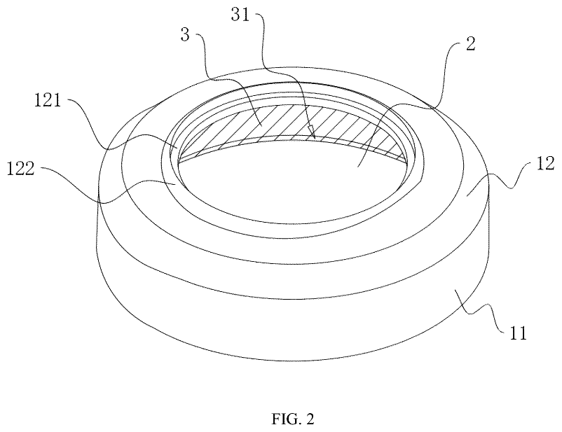

A mobile phone lens protection cover, referring to FIG. 1 and FIG. 2, includes a cover body 1, a light-transmitting lens 2 and an elastic rubber ring 3. The cover body 1 includes a side wall plate 11 which is connected end to end and a face cover 12 which closes an end of the side wall plate 11. The cover body 1 is made of metal, the side wall plate 11 matches a shape of an outer side wall of a lens, the cover body 1 matches a shape of a top surface of the lens, the side wall plate 11 and the face cover 12 are integrated into one-piece, the light-transmitting lens 2 is preferably circular, the face cover 12 defines a light-transmitting opening 123 for the lens to obtain light, and the light-transmitting lens 2 is arranged at the light-transmitting opening 123 of the face cover 12 and closes the light-transmitting opening 123, and the light-transmitting lens 2 is connected and fixed with the face cover 12. Specifically, the face cover 12 is convexly provided with a convex edge 121 on the side wall of the light-transmitting opening 123, and the convex edge 121 is annularly matched with the peripheral edge of the light-transmitting lens 2. The top surface of the convex edge 121 is coated with adhesive, and the bottom surface of the light-transmitting lens 2 is butted with the convex edge 121, and the light-transmitting lens 2 is fixed on the face cover 12 by adhesive. Furthermore, the top surface of the face cover 12 is convexly provided with a limit ring 122 matching the peripheral shape of the light-transmitting lens 2, and the side wall of the light-transmitting lens 2 abuts against the inner side wall of the limit ring 122, and the top surface of the light-transmitting lens 2 is flush with or lower than the top surface of the limit ring 122. The limit ring 122 stops the movement of the light-transmitting lens 2, which facilitates the stable installation of the light-transmitting lens 2 and helps to protect the light-transmitting lens 2 and reduce the damage caused by the collision of the light-transmitting lens 2.

As illustrated in FIG. 1 and FIG. 2, the shape of the elastic rubber ring 3 matches the shape of the side wall plate 11, and the out wall of the elastic rubber ring 3 is connected and fixed with the inner side of the side wall plate 11. The elastic rubber ring 3 is made of an elastic material such as silica gel or rubber, and the side wall plate 11 is bonded and fixed with the elastic rubber ring 3, and the inner diameter of the elastic rubber ring 3 is slightly smaller than the outer diameter of the lens.

As illustrated in FIG. 1 and FIG. 2, the end of the elastic rubber ring 3 facing away from the face cover 12 is provided with an oblique surface 31 (also referred to as inclined surface), and the oblique surface 31 forms an outward expanding flare 311, which makes the entrance position of the lens larger, so that the lens can abut against the oblique surface 31.

As illustrated in FIG. 1 and FIG. 2, the end of the side wall plate 11 facing away from the face cover 12 defines a notch 111 through which a rigid fine needle penetrates, so that the cover body 1 can be easily picked out of the lens by prying with the fine needle for separation operation.

The implementation principle of the mobile phone lens protection cover in the disclosure is as follows: an expanding position of the elastic rubber ring 3 is aligned with the lens, the top peripheral side of the lens is pressed against the oblique surface 31, the cover body 1 is pressed firmly, the oblique surface 31 guides the lens to press the elastic rubber ring 3 so that the lens falls into the cover body 1. During the process of pressing the lens into the elastic rubber ring 3, the elastic rubber ring 3 deforms, causing the lens to completely fall into the cover body 1 and be protected by the cover body 1. The elastic rubber ring 3 also presses the lens in the opposite direction, making the cover body 1 and the lens firmly combined and not easy to fall off.

Although the embodiments of the disclosure have been shown and described above, it will be understood by those skilled in the art that various changes, modifications, substitutions, and variations can be made to these embodiments without departing from the principles and spirit of the disclosure. The scope of the disclosure is limited by the appended claims and their equivalents.

What is claimed is:

1. A mobile phone lens protection cover, comprising:
a cover body (1), wherein the cover body (1) comprises an end-to-end connected side wall plate (11) and a face cover (12) which closes an end of the side wall plate (11), and the face cover (12) defines a light-transmitting opening (123);
a light-transmitting lens (2), arranged at the light-transmitting opening (123) of the face cover (12) to close the light-transmitting opening (123) and is fixedly connected with the face cover (12); and
an elastic rubber ring (3), arranged in the cover body (1), wherein an outer wall of the elastic rubber ring (3) is fixedly connected with an inner side surface of the side wall plate (11).

2. The mobile phone lens protection cover as claimed in claim 1, wherein an end of the elastic rubber ring (3) facing away from the face cover (12) is provided with an oblique surface (31), and the oblique surface (31) forms an outward expanding flare (311).

3. The mobile phone lens protection cover as claimed in claim 1, wherein an end of the side wall plate (11) facing away from the face cover (12) defines a notch (111).

4. The mobile phone lens protection cover as claimed in claim 1, wherein the face cover (12) is convexly provided with a convex edge (121) on a side wall of the light-transmitting opening (123), and a bottom surface of the light-transmitting lens (2) is butted with the convex edge (121) and fixed by adhesive.

5. The mobile phone lens protection cover as claimed in claim 4, wherein a top surface of the face cover (12) is convexly provided with a limit ring (122) matching a shape of a peripheral side of the light-transmitting lens (2), a side wall of the light-transmitting lens (2) abuts against an inner side wall of the limit ring (122), and a top surface of the light-transmitting lens (2) is flush with or lower than a top surface of the limit ring (122).
